(19) United States
(12) Patent Application Publication
(10) Pub. No.: US 2012/0244388 A1
(43) Pub. Date: Sep. 27, 2012

(54) GLASS SUBSTRATE FOR INFORMATION RECORDING MEDIA, PROCESS FOR ITS PRODUCTION, AND MAGNETIC RECORDING MEDIUM

(75) Inventors: Tetsuya NAKASHIMA, Tokyo (JP); Katsuaki Miyatani, Tokyo (JP)

(73) Assignee: Asahi Glass Company, Limited, Tokyo (JP)

(21) Appl. No.: 13/490,154

(22) Filed: Jun. 6, 2012

Related U.S. Application Data
(63) Continuation of application No. PCT/JP11/74727, filed on Oct. 26, 2011.

(30) Foreign Application Priority Data
Jan. 7, 2011 (JP) 2011-002138

(51) Int. Cl. G11B 5/84; C03C 3/04; G11B 5/73

(52) U.S. Cl. 428/846.9; 451/37; 501/53

(57) ABSTRACT

A process for producing a glass substrate for information recording media, comprising lapping a glass disk made of low alkali aluminosilicate glass that contains no alkali metal oxide or contains alkali metal oxides in a total amount of less than 4 mol %, and subsequently polishing the glass disk by using a slurry that contains cerium oxide abrasives, characterized by cleaning the glass disk by using a cleaning liquid that contains sulfuric acid at a concentration of from 20 mass % to 80 mass % and hydrogen peroxide at a concentration of from 0.5 mass % to 10 mass % at a liquid temperature of from 50° C. to 100° C., and thereafter polishing the main surface of the glass disk, by using a slurry that contains colloidal silica abrasives.

### TECHNICAL FIELD

The present invention relates to a glass substrate for information recording media, a process for its production, and a magnetic recording medium. More particularly, it relates to an improvement of a cleaning step after polishing the glass substrate.

### BACKGROUND ART

In recent years, in order to attain a high capacity of a hard disk, a glass substrate has two major technical problems to be overcome i.e. the heat resistance of the substrate and removal of foreign matters remaining on the substrate.

Along with an increase in the recording capacity of a hard disk drive, densification for a high recording density has been in progress at a high pace. However, along with the densification for a high recording density, microfabrication of magnetic particles is likely to impair thermal stability, thus leading to a problem of cross talk or a decrease in the S/N ratio of a playback signal. Under the circumstances, attention has been drawn to a thermal assist magnetic recording technique as a combined technique of optics and magnetism. This is a technique wherein a magnetic recording layer is irradiated with a laser beam or near field light to lower the coercive force locally at the heated portion, and in such a state, an external magnetic field is applied for recording, and the recorded magnetization is retrieved by e.g. GMR element, whereby recording can be made on a high coercive force medium, and it becomes possible to microfabricate magnetic particles while maintaining the thermal stability. However, in order to form a high coercive force medium in the form of a multilayered film, it is required to sufficiently heat the substrate, and a highly heat resistant substrate is desired.

Further, also for a perpendicular magnetic recording system, a magnetic recording layer different from a conventional one has been proposed in order to meet the requirement for densification for a high recording density, but for the formation of such a magnetic recording layer, the substrate is required to be heated at a high temperature, in many cases.

It is known that in order to increase the heat resistance of a substrate, low alkali aluminosilicate glass of SiO₂—Al₂O₃—B₂O₃—RO type or SiO₂—Al₂O₃—RO type (wherein RO is an alkaline earth metal oxide) is suitable, and Al₂O₃ is a component particularly effective for the improvement of the heat resistance.

On the other hand, with respect to foreign matters remaining on the glass substrate, it is known that cerium oxide abrasives which are commonly used for polishing glass for such a reason that the polishing rate is thereby high, tend to remain as foreign matters. In a process for producing a glass substrate, after polishing the main surface and edge face of a glass disk cut out from a glass plate, by using a slurry containing cerium oxide abrasives, final polishing may be carried out by using a slurry containing colloidal silica abrasives in order to further planarize the main surface. Even if cerium oxide abrasives remain on the main surface, they may be removed by the final polishing, but cerium oxide abrasives deposited on the edge face may remain without being removed and are considered to redeposit on the main surface in the cleaning step after the final polishing.

Under the circumstances, it is desired to completely remove cerium oxide abrasives, and a cleaning liquid containing an inorganic acid and ascorbic acid has been proposed (e.g. Patent Document 1 and 2). With such a cleaning liquid, by the action of the inorganic acid and ascorbic acid, the cerium oxide abrasives are dissolved and removed.

Further, it has also been proposed to use a cleaning liquid containing heated sulfuric acid as the main component, for cleaning in a final step (e.g. Patent Document 3).

### PRIOR ART DOCUMENTS

### Patent Documents

Patent Document 1: JP-A-2006-99847 (claims)
Patent Document 2: JP-A-2004-59419 (claims)
Patent Document 3: JP-A-2008-90898 (claims)

### DISCLOSURE OF INVENTION

### Technical Problem

However, when the present inventors have tested the above cleaning technique, it has been found that by the cleaning with the cleaning liquid containing ascorbic acid and an inorganic acid, it is possible to reduce cerium oxide abrasives remaining at the edge face of the glass disk, but it is not possible to completely remove them.

Further, it has been found also that since this cleaning liquid has a pH as low as from 1 to 2, it is likely to bring about substantial surface roughening when applied to a glass disk made of low alkali aluminosilicate glass. In this connection, by preparing a glass plate A made of the after-described glass A being low alkali aluminosilicate glass, and a glass plate a made of glass a containing 9.2 mol % of an alkali metal oxide (composition being, as represented by mole percentage, 66.4% of SiO₂, 4.8% of Al₂O₃, 4.6% of Na₂O, 4.6% of K₂O, 3.4% of MgO, 6.2% of CaO, 4.7% of SrO, 3.6% of BaO and 1.7% of ZrO₂), leaching tests were carried out under a condition of the pH being from 5 to 6 and under a condition of the pH being 2. As a result, under the condition of the pH being from 5 to 6, the leaching amount was from 0.2 to 0.3 nm with each of the glass plates A and a, but under the condition of the pH being 2, the leaching amount was 0.2 nm with glass plate a, while it was as large as 1.1 nm with glass plate A. That is, it is considered that low alkali aluminosilicate glass is susceptible to etching with the cleaning liquid having a low pH and thus is likely to undergo large surface roughening as mentioned above. Here, the leaching amount was measured by carrying out a quantitative analysis by ICP with respect to glass components dissolved in an aqueous solution used for the leaching test, and the above leaching tests were carried out by immersion in an aqueous solution at room temperature for 10 hours.

On the other hand, in the case of using the cleaning liquid containing heated sulfuric acid as the main component, for cleaning after the final polishing step, it was found that cerium oxide abrasive grains remaining at the edge face of the glass substrate can be almost completely removed, but large surface roughening may sometimes occur.

The present invention has been made in view of the above problems, and it is an object of the present invention to prevent retention of cerium oxide abrasives and to make it possible to provide a glass substrate for information recording media wherein surface roughening of the main surface is minimized, in a process for producing a glass substrate for information recording media from a glass disk made of low alkali aluminosilicate glass, via a polishing step using a slurry that contains cerium oxide abrasives.

### Solution to Problem

The present invention provides a glass substrate for information recording media, a process for its production and a magnetic recording medium, as shown below.

(1) A process for producing a glass substrate for information recording media, comprising a lapping step of lapping a glass disk made of low alkali aluminosilicate glass that contains no alkali metal oxide or contains at least one component selected from Li₂O, Na₂O and K₂O in a total amount of less than 4 mol %, and a cerium oxide polishing step of subsequently polishing the glass disk by using a slurry that contains cerium oxide abrasives, characterized by including, following the cerium oxide polishing step, a cleaning step of cleaning the glass disk by using a cleaning liquid that contains sulfuric acid at a concentration of from 20 mass % to 80 mass % and hydrogen peroxide at a concentration of from 0.5 mass % to 10 mass % at a liquid temperature of from 50° C. to 100° C., and a finish polishing step of polishing the main surface of the glass disk after the cleaning step, by using a slurry that contains colloidal silica abrasives.
(2) The process for producing a glass substrate for information recording media according to the above (1), wherein the low alkali aluminosilicate glass comprises, as represented by mole percentage, from 62% to 74% of SiO₂, from 7% to 18% of Al₂O₃, from 2% to 15% of B₂O₃ and from 8% to 21% in total of at least one component selected from MgO, CaO, SrO and BaO, provided that the total content of the above seven components is at least 95%, and contains less than 4% in total of at least one component selected from Li₂O, Na₂O and K₂O or does not contain any one of these three components.
(3) The process for producing a glass substrate for information recording media according to the above (1), wherein the low alkali aluminosilicate glass comprises, as represented by mole percentage, from 67% to 72% of SiO₂, from 11% to 14% of Al₂O₃, from 0% to less than 2% of B₂O₃, from 4% to 9% of MgO, from 4% to 6% of CaO, from 1% to 6% of SrO, from 0% to 5% of BaO, provided that the total content of MgO, CaO, SrO and BaO is from 14% to 18%, and the total content of the above seven components is at least 95%, and contains less than 4% in total of at least one component selected from Li₂O, Na₂O and K₂O or does not contain any one of these three components. Here, for example, “from 0% to less than 2% of B₂O₃” means that B₂O₃ is not essential but may be contained within a range of less than 2%.
(4) The process for producing a glass substrate for information recording media according to any one of the above (1) to (3), wherein the hydrogen peroxide concentration in the cleaning liquid is from 1% to 10 mass %.
(5) The process for producing a glass substrate for information recording media according to any one of the above (1) to (4), wherein the colloidal silica abrasives have an average particle size of from 10 nm to 50 nm.
(6) The process for producing a glass substrate for information recording media according to the above (5), wherein the slurry that contains the colloidal silica abrasives, has a pH of from 1 to 6.
(7) The process for producing a glass substrate for information recording media according to any one of the above (1) to (6), wherein the finish polishing step is carried out following the cleaning step.
(8) The process for producing a glass substrate for information recording media according to any one of the above (1) to (6), which includes, between the cleaning step and the finish polishing step, a repolishing step of polishing the main surface of the glass disk by using a slurry that contains cerium oxide abrasives and a polishing pad that has a foamed resin layer having a Shore A hardness of at most 60°.
(9) The process for producing a glass substrate for information recording media according to the above (5) or (6), which includes, between the cleaning step and the finish polishing step, a step of polishing the main surface of the glass disk by using a slurry that contains colloidal silica abrasives having an average particle size of more than 50 nm and at most 100 nm and that has a pH of from 8 to 12.
(10) The process for producing a glass substrate for information recording media according to any one of the above (1) to (9), wherein in the cleaning step, the glass disk is immersed in the cleaning liquid at a temperature of at least 50° C. and less than 60° C. for from 25 minutes to 30 minutes, or in the cleaning liquid at a temperature of at least 60° C. and less than 70° C. for from 15 minutes to 30 minutes, or in the cleaning liquid at a temperature of at least 70° C. and at most 100° C. for from 5 minutes to 30 minutes.
(11) The process for producing a glass substrate for information recording media according to any one of the above (1) to (10), wherein in the finish polishing step, the root-mean-square roughness (Rms) of the main surface of the glass disk is made to be at most 0.15 nm.
(12) The process for producing a glass substrate for information recording media according to any one of the above (1) to (11), which includes, after the finish polishing step, a cleaning step that is carried out by using an alkaline cleaner having a pH of at least 10.
(13) The process for producing a glass substrate for information recording media according to any one of the above (1) to (12), wherein the low alkali aluminosilicate glass contains no alkali metal oxide or contains alkali metal oxides in a total amount of less than 4 mol %.
(14) A glass substrate for information recording media, produced by the process as defined in any one of the above (1) to (13).
(15) A magnetic recording medium having a magnetic recording layer formed on the main surface of the glass substrate for information recording media as defined in the above (14).

The present inventors have investigated such a phenomenon that when a cleaning liquid containing heated sulfuric acid as the main component is used for cleaning a glass disk after the final polishing step of the glass disk, substantial surface roughening results, and have found that glass of such a glass disk is inferior in acid resistance such as sulfuric acid resistance and that such surface roughening is caused by leaching unevenness. It has been found that it is effective to use sulfuric acid at a high concentration in order to prevent such a problem, and the present invention has been accomplished on the basis of such a discovery.

Further, it has been found that in order to repair such surface roughening, it is effective to provide a finish polishing step of carrying out polishing by using a slurry that contains colloidal silica abrasives, thus arriving at the present invention.

Further, it has been found that in the case of glass with acid resistance such as sulfuric acid resistance being lower, it is possible to obtain a substrate having good surface roughness when polishing is carried out by using a slurry containing cerium oxide abrasives and a suede pad before the polishing by using the slurry containing colloidal silica abrasives, thus arriving at the present invention.

### Advantageous Effects of Invention

According to the present invention, a cleaning liquid having hydrogen peroxide added to heated sulfuric acid is used in the cleaning step, whereby it is possible to substantially eliminate retention of abrasives even if the process includes a step of polishing a glass disk made of the low alkali aluminosilicate glass by using a slurry that contains cerium oxide abrasives. Further, the surface roughening of the main surface due to leaching unevenness is repaired to present good planarity, and it is possible to provide a glass substrate for information recording media, which sufficiently satisfies a high recording capacity to be required in future.

### DESCRIPTION OF EMBODIMENTS

Now, the present invention will be described in detail with reference to an embodiment for the production of a glass substrate for a magnetic disk (a glass substrate for a hard disk). However, it should be understood that the present invention is by no means limited to such an embodiment.

Firstly, a glass disk is cut out from a glass plate made of low alkali aluminosilicate glass such as the following glass 1 or 2.

### (Glass 1)

Low alkali aluminosilicate glass that comprises, as represented by mole percentage, from 62% to 74% of SiO₂, from 7% to 18% of Al₂O₃, from 2% to 15% of B₂O₃ and from 8% to 21% in total of at least one component selected from MgO, CaO, SrO and BaO, provided that the total content of the above seven components is at least 95%, and contains less than 4% in total of at least one component selected from Li₂O, Na₂O and K₂O or does not contain any one of these three components.

### (Glass 2)

Low alkali aluminosilicate glass that comprises, as represented by mole percentage, from 67% to 72% of SiO₂, from 11% to 14% of Al₂O₃, from 0% to less than 2% of B₂O₃, from 4% to 9% of MgO, from 4% to 6% of CaO, from 1% to 6% of SrO, from 0% to 5% of BaO, provided that the total content of MgO, CaO, SrO and BaO is from 14% to 18%, and the total content of the above seven components is at least 95%, and contains less than 4% in total of at least one component selected from Li₂O, Na₂O and K₂O or does not contain any one of these three components.

Now, the respective glass compositions will be described. In the following, “mol %” will be represented simply by “%”.

### (Glass 1)

SiO₂ is an essential component. If SiO₂ is less than 62%, the glass is likely to be susceptible to scratching, and it is preferably at least 65%. If it exceeds 74%, the melting character tends to decrease, and the glass production tends to be difficult, and it is preferably at most 69%.

Al₂O₃ is an essential component. If Al₂O₃ is less than 7%, the heat resistance tends to be inadequate, and the glass is likely to undergo phase separation, whereby it tends to be difficult to maintain a smooth surface after processing and cleaning the glass substrate, or the glass is likely to be susceptible to scratching. It is preferably at least 9%. If it exceeds 18%, the melting character tends to decrease, and the glass production tends to be difficult, or the acid resistance such as sulfuric acid resistance tends to be low. It is preferably at most 12%.

Here, in order to make the glass to be less susceptible to scratching, the total content of SiO₂ and Al₂O₃ is preferably at least 70%, more preferably at least 72%.

B₂O₃ has an effect to improve the melting character of glass and is essential. If B₂O₃ is less than 2%, the melting character of glass tends to be low, and it is preferably at least 7%. If it exceeds 15%, the glass tends to undergo phase separation, and it becomes difficult to maintain a smooth surface after processing and cleaning the glass substrate, or the acid resistance such as sulfuric acid resistance tends to be low. It is preferably at most 12%.

MgO, CaO, SrO and BaO are components to improve the melting character of glass, and at least one of them must be contained. If the total content RO of these components is less than 8%, the melting character of glass tends to be low, and the glass production tends to be difficult. It is preferably at least 10%. On the other hand, if RO exceeds 21%, the glass tends to be susceptible to scratching, and it is preferably at most 16%.

Among these four components, at least one of MgO and CaO is preferably contained. If the total content MgO+CaO of MgO and CaO is less than 3%, melting of the glass is likely to be difficult, or the glass tends to be susceptible to scratching. If MgO+CaO exceeds 18%, the devitrification temperature tends to be high, whereby forming tends to be difficult.

Further, among these four components, when SrO or BaO is contained, their total content SrO+BaO is preferably at most 6%. If SrO+BaO exceeds 6%, when a cleaning liquid containing sulfuric acid is used, SrO or BaO is likely to be reacted with sulfuric acid, whereby a hardly soluble sulfate is formed, and the surface roughening is likely to be accelerated.

Glass 1 consists essentially of the above seven components, but other components may be contained in a total amount of at most 5% within a range not to impair the purpose of the present invention. If the total content of components other than the above seven components exceeds 5%, the glass tends to be susceptible to scratching. In the following, the components other than the above seven components will be exemplified.

ZnO is a component to exhibit the same effects as MgO, CaO, SrO or BaO, and may be contained within a range of at most 5%. In such a case, the total content of ZnO and RO is preferably from 8% to 21%, more preferably from 10% to 16%.

Li₂O, Na₂O and K₂O deteriorate the heat resistance, and accordingly, the total content R₂O of these three components is 0% or less than 4%. From such a viewpoint, R₂O is preferably 0%, and even if R₂O is not 0%, it is preferably less than 1%.

Oxides of atoms with atomic numbers larger than Ti, such as V, are likely to make the glass to be susceptible to scratching, and in a case where such oxides are contained, their total content is preferably at most 3%, more preferably at most 2%, particularly preferably at most 1%, most preferably at most 0.3%.

SO₃, F, Cl, As₂O₃, Sb₂O₃, SnO₂, etc. are typical components as a refining agent, and their total content is typically less than 1%.

### (Glass 2)

SiO₂ is an essential component. If SiO₂ is less than 67%, the glass tends to be susceptible to scratching, and if it exceeds 72%, the melting character tends to deteriorate, and the glass production tends to be difficult.

Al₂O₃ is an essential component. If Al₂O₃ is less than 11%, the glass is likely to undergo phase separation, and it becomes difficult to maintain a smooth surface after processing and washing the substrate, or the glass is likely to be susceptible to scratching. If it exceeds 14%, the acid resistance such as sulfuric acid resistance tends to deteriorate, or the melting character tends to deteriorate, and the glass production tends to be difficult.

B₂O₃ is not an essential component, but has an effect to improve the melting character of glass and may be contained within a range of less than 2%. If B₂O₃ is 2% or higher, the acid resistance such as sulfuric acid resistance, or the heat resistance, is likely to deteriorate.

MgO, CaO and SrO are components to be improve the melting character of glass and are essential. If the respective contents of MgO, CaO and SrO are less than 4%, less than 4% and less than 1%, respectively, the melting property tends to deteriorate. If the respective contents of MgO, CaO and SrO are more than 9%, more than 6% and more than 6%, respectively, the glass tends to be susceptible to scratching.

BaO is not an essential component, but has an effect to improve the melting character of glass, and may be contained within a range of at most 5%. If BaO exceeds 5%, the glass tends to be susceptible to scratching.

If RO is less than 14%, the melting character of glass tends to deteriorate, and the glass production tends to be difficult. On the other hand, if RO exceeds 18%, the glass tends to be susceptible to scratching.

Further, in a case where BaO is contained, SrO+BaO is preferably at most 6%. If SrO+BaO exceeds 6%, when a cleaning liquid containing sulfuric acid is employed, SrO and BaO are likely to react with sulfuric acid, whereby a hardly soluble sulfate is likely to be formed, and the surface roughening is likely to be accelerated.

Glass 2 consists essentially of the above seven components, but may contain other components in a total amount of at most 5% within a range not to impair the purpose of the present invention. If the total content of components other than the above seven components exceeds 5%, the glass tends to be susceptible to scratching. In the following, the components other than the above seven components will be exemplified.

ZnO is a component to exhibit the same effects as MgO, CaO, SrO or BaO, and may be contained within a range of at most 5%. In such a case, the total content of ZnO and RO is preferably from 8% to 21%, more preferably from 10% to 16%.

Li₂O, Na₂O and K₂O lower the annealing point, and therefore, the total content R₂O of these three components is 0% or less than 4%. From such a viewpoint, R₂O is preferably 0%, and even in a case where R₂O is not 0%, it is preferably less than 1%.

Oxides of atoms with atomic numbers larger than Ti, such as V, are likely to make the glass to be susceptible to scratching, and in a case where such oxides are contained, their total content is preferably at most 3%, more preferably at most 2%, particularly preferably at most 1%, most preferably at most 0.3%.

SO₃, F, Cl, As₂O₃, Sb₂O₃, SnO₂, etc. are typical components as a refining agent, and their total content is typically less than 1%.

The glass constituting the glass substrate of the present invention (hereinafter sometimes referred to as the substrate glass) preferably has an annealing point TA of at least 650° C. If TA is less than 650° C., the glass is likely to undergo warpage during formation of a magnetic recording layer, whereby it tends to become difficult to carry out reading or writing normally. The annealing point is more preferably at least 680° C., particularly preferably at least 700° C. and typically at most 750° C.

The cracking rate p (unit: %) of the substrate glass is preferably at most 50%. If p exceeds 50%, the glass tends to be susceptible to scratching, i.e. stress concentration tends to take place, and as a result, brittle fracture tends to occur by a weak stress. The cracking rate p is more preferably at most 30%, particularly preferably at most 10%.

The cracking rate p is measured as follows.

The glass is polished with cerium oxide abrasives having an average particle size of 2 mm and then polished with colloidal silica abrasives having an average particle size of 20 nm to prepare a glass plate having a thickness of from 1 to 2 mm, a size of 4 cm×4 cm and the after-described Ra of at most 15 nm. This glass plate is held at TA or at the glass transition temperature for 30 minutes and then cooled to room temperature at a rate of 1° C./min or less. On the surface of this glass plate, a Vickers indenter is impressed with a load of 1,000 g in a room controlled to have a temperature of 23° C. and a relative humidity of 70%, whereby the number of cracks formed from its four apexes is measured. This measurement is repeated 10 times, whereupon “100×(sum of the numbers of cracks)÷40” is taken as p.

The hydrochloric acid resistance of the substrate glass is preferably at most 0.1 mg/cm². If the hydrochloric acid resistance exceeds 0.1 mg/cm², surface roughness is likely to occur in a step of polishing or cleaning wherein an acid is employed.

The hydrochloric acid resistance is measured as follows.

The glass is immersed in 0.1 N hydrochloric acid at 90° C. for 20 hours, whereby the weight reduction is measured, and the obtained value is divided by the surface area of the sample to obtain the hydrochloric acid resistance.

Further, the sulfuric acid resistance of the substrate glass is preferably at most 5 nm/h. If the sulfuric acid resistance exceeds 5 nm/h, surface roughness is likely to be accelerated when a cleaning liquid containing sulfuric acid is employed, or surface roughening is likely to occur in a step of polishing or cleaning wherein an acid is employed.

The sulfuric acid resistance is measured as follows.

The glass is immersed in sulfuric acid having a concentration of 16 mass % at 60° C. for 5 hours, whereby with respect to glass components dissolved into the aqueous solution, quantitative analyses are carried out by ICP, and the etching rate of the glass is calculated.

Further, the process for producing a glass plate is not particularly limited, and various processes may be used. For example, raw materials of various components which are commonly used, are mixed to have a desired composition, and such a mixture is heated and melted by a glass melting furnace. By bubbling, stirring, addition of a refining agent, etc., the glass is homogenized and formed into a sheet glass having a prescribed thickness by a well known method such as a float process, a press method, a fusion method or a downdraw method, and after annealing, the sheet glass is subjected to processing such as lapping or polishing, as the case requires and then processed into a glass substrate having a prescribed size and shape. As the forming method, a float process is particularly preferred, which is suitable for mass production. Further, a continuous forming method other than the float process, i.e. a fusion method or a downdraw method may also suitably be used.

Then, a circular hole is formed at the center of the glass disk, followed by chamfering, lapping of the main surface and mirror polishing of the edge face, sequentially. Here, the step of lapping of the main surface may be divided into a rough lapping step and a fine lapping step, and between them, a shape-processing step (for forming a hole at the center of the circular glass plate, chamfering and polishing of the edge face) may be provided. Further, for the mirror polishing of the edge face, glass disks may be stacked, and inner peripheral edge faces may be subjected to brush polishing using cerium oxide abrasives and then to etching treatment, or instead of brush polishing of the inner peripheral edge faces, e.g. a polysilazane compound-containing liquid is applied by e.g. a spraying method to the inner peripheral edge faces treated by etching, followed by firing to form a coating film (a protective coating film) on the inner peripheral edge faces. The lapping of the main surface is usually carried out by using aluminum oxide abrasives or aluminum oxide-type abrasives having an average particle size of from 6 to 8 μm. The lapped main surface is usually polished for from 30 to 40 μm.

In such a processing, in a case where a glass substrate having no circular hole formed at the center is to be produced, forming of a hole at the center of the glass substrate and mirror polishing of the inner peripheral edge face are, of course, unnecessary.

Thereafter, the main surface of the glass disk is polished by using a slurry that contains cerium oxide abrasives. This main surface-polishing step is carried out by means of a polishing pad made of urethane, and for example, by means of a three dimensional surface structure-analyzing apparatus (e.g. Opti-flat manufactured by ADE), polishing is carried out so that waviness (Wa) measured under such a condition that the wavelength (λ) region is λ≦5 mm, will be at most 1 nm. Further, the decreased degree in the plate thickness by polishing (the polishing degree) is typically from 5 to 15 μm. The main surface-polishing step may be carried out by polishing only once, or twice or more by using cerium oxide abrasives different in the size. Here, cerium oxide abrasives are known ones and usually contain a rare earth such as lanthanum, fluorine, etc. in addition to cerium oxide. Further, the cerium oxide polishing step of the present invention includes the main surface polishing step with cerium oxide for the purpose of removing flaws formed in the lapping step, and without limited thereto, includes mirror polishing of the edge face after the lapping step, if such mirror polishing is carried out.

Then, cleaning of the glass disk is carried out. In this cleaning step, a step of immersion in pure water is carried out, and then, a step of immersion in a cleaning liquid having sulfuric acid and hydrogen peroxide mixed and heated is carried out, and a step of finally rinsing with pure water is preferably carried out. Further, prior to this cleaning step, a prior-cleaning step using an acidic cleaning agent or an alkaline cleaning agent may be carried out. Further, in the immersion step or rinsing step by using pure water, ultrasonic cleaning may be used in combination, or cleaning by running water or shower water may be carried out.

In the cleaning liquid, the sulfuric acid concentration is at least 20 mass % and at most 80 mass %, and the hydrogen peroxide concentration is at least 1 mass % and at most 10 mass %. Preferably, the sulfuric acid concentration is at least 50 mass % and at most 80 mass %, and the hydrogen peroxide concentration is at least 3 mass % and at most 10 mass %. If the concentrations of sulfuric acid and hydrogen peroxide are lower than these ranges, the cerium oxide abrasives will remain without being dissolved. If the concentrations of sulfuric acid and hydrogen peroxide are higher than these ranges, the surface roughening of the above low alkali aluminosilicate glass by leaching tends to be remarkable, whereby the desired planarity tends to be hardly obtainable even if the after-mentioned finish polishing is carried out, and a glass jig made of a resin to be commonly used tends to be oxidized and decomposed, such being undesirable. Further, for the same reasons, the liquid temperature of the cleaning liquid is preferably at least 50° C. and at most 100° C., and the immersion time is preferably at least 5 minutes and at most 30 minutes. Specifically, it is preferred to immerse the glass disk in a cleaning liquid at a temperature of at least 50° C. and lower than 60° C. for from 25 minutes to 30 minutes, in a cleaning liquid at a temperature of at least 60° C. and lower than 70° C. for from 15 minutes to 30 minutes, or in a cleaning liquid at a temperature of at least 70° C. and at most 100° C., for from 5 minutes to 30 minutes.

In the above cleaning step, sulfuric acid is used, whereby leaching unevenness may occur, and therefore, the main surface of the glass disk is subjected to polishing again to improve the planarity (finish polishing step). Further, there is a case where cerium oxide abrasives remaining at the edge face of the glass disk may be re-deposited on the main surface, but such re-deposited abrasive grains may also be removed.

In the finish polishing step, final polishing is carried out by using a slurry that contains colloidal silica abrasives. In the finish polishing step, polishing may simply be carried out by using a slurry that contains colloidal silica abrasives having an average particle size of preferably from 10 nm to 50 nm, or preliminary polishing may be carried out by using a slurry that contains colloidal silica abrasives having an average particle size of more than 50 nm and at most 100 nm and then finish polishing may be carried out by using a slurry that contains colloidal silica abrasives having an average particle size of from 10 nm to 50 nm.

In the case of glass that is poor in acid resistance such as sulfuric acid resistance, it is preferred to carry out polishing by using a suede pad and a slurry that contains cerium oxide abrasives, prior to the finish polishing step (repolishing step). Such a suede pad is preferably one having a foamed resin layer with a Shore A hardness of at most 60° bonded to a nonwoven fabric or polyethylene terephthalate (PET). If the Shore A hardness exceeds 60°, there may be a case where it is required to make the porosity small, and it tends to be difficult to maintain the hydrophilicity. Further, the Shore A hardness is preferably at least 20°. If the Shore A hardness is less than 20°, the polishing rate tends to be slow. Further, such a foamed resin layer may be a single layer or one wherein two or more foamed layers different in morphology are laminated. In the latter case, it is preferred that the first foamed resin layer in contact with the glass has a Shore A hardness of at least 20° and at most 50°, the second foamed resin layer as the lower layer has a Shore A hardness of at least 40° and at most 60°, and the first foamed layer has a hardness lower than the second foamed layer. Here, such a foamed resin layer is typically a polyurethane. Particularly, the suede pad is typically one made of a foamed urethane resin that has a Shore A hardness of from 30° to 60°, a compressibility of from 0.5 to 10% and a density of from 0.2 to 0.9 g/cm³.

The slurry that contains cerium oxide abrasives, is preferably an aqueous alkaline slurry having a pH of at least 8. By adjusting the pH, it is possible to improve the dispersibility of cerium oxide abrasives and to highly control the abrasive grain residue at the peripheral edge area of the glass disk.

Here, the abrasive grain size is preferably at least 0.1 μm as a diameter calculated from the BET specific surface area. If the calculated diameter is less than 0.1 μm, abrasive grains are likely to be packed into the foamed resin layer of the suede pad, whereby the polishing rate is likely to deteriorate. To the slurry, a polycarboxylic acid salt or an organic acid salt may be incorporated to prevent agglomeration of cerium oxide abrasives. Usually, a polyacrylic acid salt, a polysulfonic acid salt, a polymaleic acid salt or a copolymer thereof is used in many cases, and one having a molecular weight of from 2,000 to 100,000 is added in an amount of from 0.1 to 5 mass %, based on the amount of the abrasives.

The Shore A hardness is measured by a method for measuring a durometer A hardness of a plastic as stipulated in JIS K7215. Further, the compressibility (unit: %) is measured as follows. That is, with respect to a test sample cut out from the polishing pad in a proper size, a load of a stress of 10 kPa is applied for 30 seconds by means of a schopper type thickness measuring apparatus from a non-loaded state, whereupon the thickness t₀ of the material is obtained, and then, from the state where the thickness is t₀, a load of a stress of 110 kPa is immediately applied for 5 minutes, whereupon the thickness t₁ of the material is obtained, and from the values of t₀ and t₁, (t₀−t₁)×100/t₀ is calculated, and the calculated value is taken as the compressibility.

In the polishing with the slurry that contains colloidal silica abrasives, in the case of colloidal silica using water glass as the raw material, gelation is likely to proceed usually in a neutral region, and therefore, it is preferred to carry out the polishing at a pH of at least 1 and at most 6, or at least 2 and at most 6, or at a pH of at least 8 and at most 12. As a pH adjustor for adjusting to an acidic region of a pH of at least 1 and at most 6, an inorganic acid or an organic acid is used as an acid. The inorganic acid may, for example, be hydrochloric acid, nitric acid, sulfuric acid, phosphoric acid, polyphosphoric acid or sulfamic acid. The organic acid may, for example, be a carboxylic acid, an organic phosphoric acid or an amino acid. For example, the carboxylic acid may be a monobasic carboxylic acid such as acetic acid, glycolic acid or ascorbic acid, a dibasic carboxylic acid such as oxalic acid or tartaric acid, or a tribasic carboxylic acid such as citric acid. It is particularly preferred to bring the pH to at least 1 and at most 3, and in such a case, an inorganic acid is preferably used. Further, in a case where the pH is more than 3, it is preferred to employ a carboxylic acid, whereby gelation of colloidal silica abrasives can be prevented. Further, an anionic or nonionic surfactant may be added to the slurry. On the other hand, in a case where the pH is adjusted to be at least 8 and at most 12, the pH adjustor may contain at least one of an inorganic alkali such as sodium hydroxide, potassium hydroxide or lithium hydroxide, or an organic alkali such as ammonia or an amine. Further, various surfactants may also be added. Here, the polishing tool is preferably a suede pad. This suede pad is typically a suede pad which is mentioned above as preferably used in the above-described repolishing step, and the foamed resin layer preferably has a Shore A hardness of at least 20° and at most 60° and a density of at least 0.2 g/cm³ and at most 0.8 g/cm³.

Further, the finish polishing step may be carried out without via the polishing (repolishing step) with the slurry that contains cerium oxide abrasives.

Which polishing method should be adopted after the cleaning step by using sulfuric acid and hydrogen peroxide, is selected depending upon the state of the main surface of the glass disk after the cleaning. In a case where the surface roughening of the main surface is remarkable since the glass is poor in acid resistance such as sulfuric acid resistance, it is preferred to carry out polishing by using the slurry that contains cerium oxide abrasives and then to carry out the final polishing with the slurry that contains colloidal silica abrasives. In a case where the surface roughening of the main surface is an intermediate level, without polishing by using the slurry that contains cerium oxide abrasives, polishing may be carried out by using the slurry that contains colloidal silica abrasives having an average particle size of more than 50 nm and at most 100 nm and then polishing may be carried out by using the slurry that contains colloidal silica abrasives having an average particle size of at least 10 nm and at most 50 nm. Further, in a case where the surface roughening of the main surface is little, without polishing by using the slurry that contains cerium oxide abrasives, polishing may be carried out by using the slurry that contains colloidal silica abrasives having an average particle size of from 10 nm to 50 nm.

By the above finish polishing step, the glass disk is preferably polished to have a planarity such that the root-mean-square roughness (Rms) of the main surface is at most 0.15 nm, preferably at most 0.13. The thickness reduction (polished degree) in this polishing is typically from 0.5 to 2 μm. Further, the arithmetic mean roughness (Ra) of the main surface is preferably at most 0.14 nm, more preferably at most 0.12 nm. Here, the measurement area for Rms and Ra is usually 10 μm×10 μm.

After the finish polishing step, cleaning is carried out to remove colloidal silica abrasives. In this cleaning step, it is preferred to carry out cleaning with an alkaline cleaning agent having a pH of at least 10, for at least once. As the cleaning method, the glass disk may be immersed, and ultrasonic vibration may be applied, or scrub cleaning may be employed. Or, both may be used in combination. Further, it is preferred to carry out an immersion step or rinsing step with pure water before and after the cleaning.

After the final rinsing step, the glass disk is dried, and as the drying method, a drying method wherein an isopropyl alcohol vapor is employed, a spin drying or a vacuum drying may, for example, be used.

By the above-described series of steps, the glass substrate of the present invention is obtainable, and the main surface is highly planarized and free from residual cerium oxide abrasives. Therefore, high density recording becomes possible with the magnetic recording medium of the present invention having a magnetic recording medium applied on the main surface.

### Examples

Now, the present invention will be described in detail with reference to Examples, but it should be understood that the present invention is by no means thereby restricted.

### (Test 1)

A glass plate made of glass A formed by a float process and having the following composition and physical properties, is prepared.

Composition represented by mole percentage: 66.2% of SiO₂, 11.3% of Al₂O₃, 7.6% of B₂O₃, 5.3% of MgO, 4.7% of CaO and 4.9% of SrO.
Specific gravity: 2.50
Hydrochloric acid resistance: 0.1 mg/cm²
Sulfuric acid resistance: 2.0 nm/h
Annealing point: 725° C.
Cracking rate p: 0%

From this glass plate, a doughnut-form glass disk (glass disk having a circular hole at the center) having an outer diameter of 65 mm, an inner diameter of 20 mm and a thickness of 0.635 mm, is cut out. The inner peripheral face and the outer peripheral face of this glass disk are subjected to grinding by means of a diamond grindstone, and the upper and lower main surfaces are subjected to lapping by using aluminum oxide abrasives.

Then, the edge face of the inner periphery is subjected to chamfering with a chamfering width of 0.15 mm at a chamfering angle of 45°.

After the chamfering, the edge face is subjected to mirror processing by brush polishing by using a slurry that contains cerium oxide abrasives as a polishing material and using a brush as a polishing tool. The polishing degree i.e. the removal degree in the radius direction in the mirror processing is 30 μm.

After the mirror processing, the upper and lower main surfaces are subjected to polishing by using a slurry that contains cerium oxide abrasives (average particle size: about 2 μm) as a polishing material and using a urethane pad as a polishing tool by means of a double-sided polishing apparatus. The polishing degree is 35 μm in total in the thickness direction of the upper and lower main surfaces. Thereafter, ultrasonic cleaning with an alkali cleaner and rinsing with pure water are carried out.

Then, the upper and lower main surfaces are subjected to polishing by means of a double-sided polishing apparatus by using a slurry that contains cerium oxide abrasives (average particle size: about 0.5 μm) as a polishing material, and using a suede pad having a foamed urethane layer with a Shore A hardness of 60° laminated on a polyethylene terephthalate (PET) layer, as a polishing tool. The polishing degree is 5 μm in the thickness direction. Thereafter, ultrasonic cleaning with an alkaline cleaner and rinsing with pure water are carried out.

Then, the upper and lower main surfaces are subjected to finish polishing by means of a double-sided polishing apparatus by using a slurry that contains colloidal silica abrasives (average particle size: 30 nm) as a polishing material and is adjusted to pH 4.8 with citric acid, and using a suede pad (Shore A hardness: about 42°) having a foamed urethane layer with a Shore A hardness of 55° laminated on a polyethylene terephthalate layer and having a foamed urethane layer with a Shore A hardness of 34° laminated thereon, as a polishing tool. The polishing degree is 1 μm in total in the thickness direction of the upper and lower main surfaces.

Then, as a cleaning step to remove colloidal silica, an immersion cleaning with an alkaline cleaner, scrub cleaning, ultrasonic cleaning, rinsing with pure water and drying by using isopropyl alcohol vapor, are sequentially carried out.

Rms of the main surfaces is measured by AFM, whereby Rms is from 0.10 to 0.13 nm.

Then, cleaning is carried out by immersion for 15 minutes in a cleaning liquid (solvent: water) of 80° C. that contains sulfuric acid and hydrogen peroxide at concentrations (unit: mass %) shown in trials 1 to 3 in Table 1. After the cleaning, Rms of the main surfaces is measured by AFM and found to be as shown in Table 1 (unit: nm).

Each of trials 1 to 3 is Comparative Example, and irrespective of the sulfuric acid concentration as shown in Table 1, surface roughening takes place, and Rms shows a value as large as at least 0.2 nm.

TABLE 1

| | | Aqueous hydrogen | |
|---|---|---|---|
| Trials | Sulfuric acid | peroxide solution | Rms |
| 1 | 5 | 7.7 | 0.20 |
| 2 | 40 | 7.7 | 0.25 |
| 3 | 71.4 | 7.7 | 0.25 |

### (Test 2)

Under the same processing conditions as in Test 1, a glass disk is cut out from a glass plate made of glass A, and grinding of the inner peripheral face and the outer peripheral face, lapping of the upper and lower surfaces, chamfering and mirror processing of the inner periphery and polishing of the upper and lower surfaces with the slurry that contains cerium oxide abrasives, are carried out.

After polishing the main surfaces, the glass disk is subjected to immersion cleaning with pure water as preliminary cleaning, ultrasonic cleaning with an alkali cleaner and rinsing with pure water, and then, cleaning is carried out by immersion for 15 minutes in a cleaning liquid (solvent: water) of 80° C. that contains sulfuric acid and hydrogen peroxide at concentrations (unit: mass %) as shown in trials 4 to 14 in Table 2. Here, the cleaning liquid in trial 8 does not contain hydrogen peroxide, and the cleaning liquid in trial 14 does not contain sulfuric acid.

After the cleaning, under the same conditions as in Test 1, polishing is carried out with the slurry that contains colloidal silica abrasives, and then, cleaning and drying are carried out. Thereafter, Rms of the main surfaces is measured by AFM and found to be from 0.10 to 0.13 nm in each case.

Thereafter, the outer peripheral edge race of the glass disk is observed by means of SEM-EDX (apparatus name: S4700, manufactured by Hitachi, Ltd.) to investigate the remaining state of cerium oxide abrasives. That is, optional 8 portions at the outer peripheral edge face are enlarged 5,000 times by means of SEM, whereby the number of particulate deposits is counted, and with respect to the particulate deposits, an elemental analysis is carried out by EDX to ascertain whether or not the deposits are cerium oxide, whereby the remaining state of cerium oxide abrasives is as shown in the column for “remaining abrasives” in Table 2. Here, a case where no deposition is observed in all of the 8 portions, is identified with “⊚”, a case wherein deposits are observed at from 1 to 4 portions is identified with “∘”, and a case where deposits are observed at 5 portions or more is identified with “x”.

Trials 4 to 7 and 9 to 13 are Examples of the present invention, wherein even in a case where deposits are present, their presence is at most at 4 portions, but in trials 8 and 14 being Comparative Examples, deposits are observed at at least 5 portions.

TABLE 2

| Trials | Sulfuric acid | Hydrogen peroxide | Remaining abrasives |
|---|---|---|---|
| 4 | 71.4 | 7.7 | ⊚ |
| 5 | 71.4 | 3.0 | ⊚ |
| 6 | 71.4 | 1.1 | ⊚ |
| 7 | 71.4 | 0.5 | ◯ |
| 8 | 71.4 | 0 | X |
| 9 | 71.4 | 7.7 | ⊚ |
| 10 | 60 | 7.7 | ◯ |
| 11 | 50 | 7.7 | ◯ |
| 12 | 40 | 7.7 | ◯ |
| 13 | 20 | 7.7 | ◯ |
| 14 | 0 | 7.7 | X |

### (Test 3)

A glass plate made of glass A and a glass plate made of glass B having the following composition, formed by a float process, were prepared.

Composition represented by mol %: 64.8% of SiO₂, 11.9% of Al₂O₃, 1.8% of ZrO₂, 12.6% of Li₂O, 5.4% of Na₂O and 3.4% of K₂O.

From each of these glass plates, a doughnut-form glass disk (glass disk having a circular hole at the center) having an outer diameter of 65 mm, an inner diameter of 20 mm and a thickness of 0.635 mm, was cut out, and its inner peripheral face and outer peripheral face were subjected to grinding by means of a diamond grindstone, and the upper and lower main surfaces were subjected to lapping by using aluminum oxide abrasives.

Then, the inner and outer peripheral edge faces were subjected to chamfering with a chamfering width of 0.15 mm at a chamfering angle of 45°.

After the chamfering, the edge faces were subjected to mirror processing by brush polishing by using a slurry that contained cerium oxide abrasives as a polishing material and using a brush as a polishing tool. The polished degree i.e. the removal degree in the radial direction in the mirror processing was 30 μm.

After the mirror processing the upper and lower main surfaces were subjected to polishing by means of a double-sided polishing apparatus by using a slurry that contained cerium oxide grains (average particle size: about 2 μm) as a polishing material and using a urethane pad as an polishing tool. The polished degree was 35 μm in total in the thickness direction of the upper and lower main surfaces. Thereafter, ultrasonic cleaning with an alkali cleaner and rinsing with pure water were carried out.

Then, the upper and lower main surfaces were subjected to polishing by means of a double-sided polishing apparatus by using a slurry that contained cerium oxide abrasives (average particle size: about 0.5 μm) as a polishing material and using a suede pad having a foamed urethane layer with a Shore A hardness of 60° laminated on a polyethylene terephthalate (PET) layer, as a polishing tool. The polished degree was 5 μm in the thickness direction. Thereafter, ultrasonic cleaning with an alkali cleaner and rinsing with pure water were carried out.

Then, the upper and lower main surfaces were subjected to finish polishing by means of a double-sided polishing apparatus by using a slurry that contained colloidal silica abrasives (average particle size: 30 nm) as a polishing agent and was adjusted to pH 4.1 with citric acid, and using a suede pad (Shore A hardness: about 42°) having a foamed urethane layer with a Shore A hardness of 55° laminated on a polyethylene terephthalate layer and having a foamed urethane layer with a Shore A hardness of 34° laminated thereon, as a polishing tool. The polished degree was 1 μm in total in the thickness direction of the upper and lower main surfaces.

With respect to the glass disk A or B made of glass A or B thus obtained, cleaning was carried out by immersion for 2 minutes, 5 minutes and 10 minutes in a cleaning liquid (solvent: water) of 80° C. that contained 71.4 mass % of sulfuric acid and 7.7 mass % of hydrogen peroxide, and then cleaning was carried out with water, whereupon the arithmetic average roughness Ra of the main surfaces of each glass disk was measured by means of AFM (model: SPM400), manufactured by Seiko Instruments, Inc. The measured results of Ra (unit: nm) are shown in Table 3. Here, in the column where the immersion time (unit: minute) is 0, Ra of the glass disk before immersion in the above cleaning liquid is shown.

From the results, the following was found. That is, with respect to the glass disk A, it was found that Ra became large as projections such as the after-described asperity were formed on the main surfaces when the disk was immersed for at least 2 minutes. With respect to the glass disk B, it was found that Ra became large, as projections were formed when immersed for at least 5 minutes. These projections are considered to be a compound formed by a reaction of sulfuric acid used in the cleaning liquid and the alkaline earth metal in the glass.

Further, with respect to the glass disk B, when the immersion time is not more than 5 minutes, Ra does not become so large, although small projections may be observed. This indicates that with glass A containing no alkali metal oxide, the durability against the above cleaning liquid is inferior to glass B, and large surface roughening takes place. Here, the reason as to why the above durability of glass A is inferior to glass B, is considered to be such that glass A contains SrO and BaO.

TABLE 3

| Immersion time | 0 | 2 | 5 | 10 |
|---|---|---|---|---|
| Glass disk A | 0.164 | 0.234 | 0.285 | 0.364 |
| Glass disk B | 0.136 | 0.152 | 0.141 | 0.288 |

Further, from an AFM image in a square region of 1,000 nm×1,000 nm obtained at the time of the above measurement by AFM, the number of asperity was counted. The results are shown in Table 4. Here, the asperity is, among projections, ones which have a height h of at least 1 nm and of which a ratio (h/w) of the height h to the half value width w i.e. the width of a projection at a height of h/2 of the projection, is at least 2.

From the results, it is evident that with the glass disk A, a large amount of asperity is formed in 2 minutes of the immersion time in the above cleaning liquid, while with the glass disk B, a large amount of asperity is not formed even in 5 minutes of the immersion time. That is, with glass A, asperity is likely to be formed as compared with glass B, and also from this point, it is evident that glass A is inferior in the durability against the above cleaning liquid.

TABLE 4

| Immersion time | 0 | 2 | 5 | 10 |
|---|---|---|---|---|
| Glass disk A | 0 | 7 | 11 | 18 |
| Glass disk B | 0 | 0 | 2 | 8 |

### (Test 4)

With respect to the glass disks A and B cleaned with water after immersed for 10 minutes in the cleaning liquid in Test 3, scrub cleaning was carried out with an alkali cleaner by using a sponge made of a polyvinyl alcohol. Then, cleaning with water was carried out, and Ra of the main surfaces was measured in the same manner as in Test 3, and it was 0.180 nm and 0.140 nm, respectively, and no asperity was observed on each of the glass disks, and it was found that the asperity can be removed by alkali cleaning. Further, it was found that with the glass disk A, Ra decreases by alkali cleaning, but Ra does not return to a level of 0.164 nm before the cleaning with the above cleaning liquid, while with the glass disk B, Ra substantially returns to the Ra value of 0.136 nm before the cleaning with the above cleaning liquid, by the alkali cleaning.

From the results, the following is evident. That is, the asperity can be removed by alkali cleaning, but with the glass disk A, its main surfaces are roughened by the surface reaction which brings about formation of asperity.

### (Test 5)

Glass disks A and B were prepared in the same manner as in the preparation of the glass disks A and B by immersion in the cleaning liquid in Test 3.

The glass disk A thus obtained was immersed for cleaning for 10 minutes in one of three types of cleaning liquids (solvent: water) of 80° C. that contain 7.7 mass % of hydrogen peroxide, and 30 mass %, 45 mass % and 71.4 mass % of sulfuric acid, and then cleaned with water. With respect to three types of glass disk A thus cleaned, polishing was carried out by using a polishing slurry that had a concentration of colloidal silica abrasives with an average particle size of 30 nm of 10 mass % and adjusted so that the pH became 4.1, so that the polishing degree A became 0.25 μm, 0.5 μm and 1 μm, respectively, and scrub cleaning with an alkali cleaner was carried out by means of a sponge made of a polyvinyl alcohol, and thereafter, cleaning with water was carried out, and Ra of the main surfaces was measured in the same manner as in Test 3.

Further, also with respect to the glass disk B, cleaning was carried out by immersion for 10 minutes in a cleaning liquid (solvent: water) of 80° C. that contained 7.7 mass % of hydrogen peroxide and 30 mass % of sulfuric acid, and then cleaning was carried out with water. With respect to the glass disk B thus cleaned, polishing was carried out by using the above polishing slurry so that the polishing degree A became 0.25 μm, 0.5 μm and 1 μm, respectively, the above scrub cleaning was carried out, and then cleaning with water was carried out, whereupon Ra was measured in the same manner as in Test 3.

The measured results of Ra (unit: nm) are shown in Table 5. The numerical values in the column for the sulfuric acid concentration are the sulfuric acid concentrations (unit: mass %) of the above cleaning liquids, and for example, Δ=0.25 shows that the polishing degree Δ in the above polishing is 0.25 μm. The numerical values in the column for Δ=0 is Ra of the glass disks before polishing with the above polishing slurry.

From the results, the following is evident. That is, with each of the glass disks A and B, Ra becomes small by the above polishing, but with the glass disk A, such an effect is remarkable, and Ra decreases from a level of from 0.17 to 0.19 nm before the polishing to a level of from 0.08 to 0.11 nm corresponding to the preferred range as Ra, after the polishing.

TABLE 5

| | Sulfuric acid | | | | |
|---|---|---|---|---|---|
| Glass disk | concentration | Δ = 0 | Δ = 0.25 | Δ = 0.5 | Δ = 1.0 |
| A | 30 | 0.165 | 0.106 | 0.100 | 0.101 |
| A | 45 | 0.193 | 0.092 | 0.096 | 0.097 |
| A | 71.4 | 0.189 | 0.090 | 0.082 | 0.084 |
| B | 30 | 0.127 | 0.092 | 0.092 | 0.092 |

### INDUSTRIAL APPLICABILITY

According to the process for producing a glass substrate for information recording media of the present invention, even if it has a polishing step by using a slurry that contains cerium oxide abrasives, a glass disk made of low alkali aluminosilicate glass can be made substantially free from residue of abrasive grains, and the surface roughening of the main surface due to leaching unevenness is repaired to provide good planarity, and thus the process is useful for the production of a glass substrate for magnetic recording media, that sufficiently satisfies a high recording capacity to be required in future.

This application is a continuation of PCT Application No. PCT/JP2011/074727, filed Oct. 26, 2011, which is based upon and claims the benefit of priority from Japanese Patent Application No. 2011-2138 filed on Jan. 7, 2011. The contents of those applications are incorporated herein by reference in its entirety.

What is claimed is:

1. A process for producing a glass substrate for information recording media, comprising a lapping step of lapping a glass disk made of low alkali aluminosilicate glass that contains no alkali metal oxide or contains alkali metal oxides in a total amount of less than 4 mol %, and a cerium oxide polishing step of subsequently polishing the glass disk by using a slurry that contains cerium oxide abrasives, characterized by including, following the cerium oxide polishing step, a cleaning step of cleaning the glass disk by using a cleaning liquid that contains sulfuric acid at a concentration of from 20 mass % to 80 mass % and hydrogen peroxide at a concentration of from 0.5 mass % to 10 mass % at a liquid temperature of from 50° C. to 100° C., and a finish polishing step of polishing the main surface of the glass disk after the cleaning step, by using a slurry that contains colloidal silica abrasives.

2. The process for producing a glass substrate for information recording media according to claim 1, wherein the low alkali aluminosilicate glass comprises, as represented by mole percentage, from 62% to 74% of SiO₂, from 7% to 18% of Al₂O₃, from 2% to 15% of B₂O₃ and from 8% to 21% in total of at least one component selected from MgO, CaO, SrO and BaO, provided that the total content of the above seven components is at least 95%, and contains less than 4% in total of at least one component selected from Li₂O, Na₂O and K₂O or does not contain any one of these three components.

3. The process for producing a glass substrate for information recording media according to claim 1, wherein the low alkali aluminosilicate glass comprises, as represented by mole percentage, from 67% to 72% of SiO₂, from 11% to 14% of Al₂O₃, from 0% to less than 2% of B₂O₃, from 4% to 9% of MgO, from 4% to 6% of CaO, from 1% to 6% of SrO, from 0% to 5% of BaO, provided that the total content of MgO, CaO, SrO and BaO is from 14% to 18%, and the total content of the above seven components is at least 95%, and contains less than 4% in total of at least one component selected from Li₂O, Na₂O and K₂O or does not contain any one of these three components.

4. The process for producing a glass substrate for information recording media according to claim 1, wherein the hydrogen peroxide concentration in the cleaning liquid is from 1% to 10 mass %.

5. The process for producing a glass substrate for information recording media according to claim 1, wherein the colloidal silica abrasives have an average particle size of from 10 nm to 50 nm.

6. The process for producing a glass substrate for information recording media according to claim 5, wherein the slurry that contains the colloidal silica abrasives, has a pH of from 1 to 6.

7. The process for producing a glass substrate for information recording media according to claim 1, wherein the finish polishing step is carried out following the cleaning step.

8. The process for producing a glass substrate for information recording media according to claim 1, which includes, between the cleaning step and the finish polishing step, a repolishing step of polishing the main surface of the glass disk by using a slurry that contains cerium oxide abrasives and a polishing pad that has a foamed resin layer having a Shore A hardness of at most 60°.

9. The process for producing a glass substrate for information recording media according to claim 5, which includes, between the cleaning step and the finish polishing step, a step of polishing the main surface of the glass disk by using a slurry that contains colloidal silica abrasives having an average particle size of more than 50 nm and at most 100 nm and that has a pH of from 8 to 12.

10. The process for producing a glass substrate for information recording media according to claim 1, wherein in the cleaning step, the glass disk is immersed in the cleaning liquid at a temperature of at least 50° C. and less than 60° C. for from 25 minutes to 30 minutes, or in the cleaning liquid at a temperature of at least 60° C. and less than 70° C. for from 15 minutes to 30 minutes, or in the cleaning liquid at a temperature of at least 70° C. and at most 100° C. for from 5 minutes to 30 minutes.

11. The process for producing a glass substrate for information recording media according to claim 1, wherein in the finish polishing step, the root-mean-square roughness (Rms) of the main surface of the glass disk is made to be at most 0.15 nm.

12. The process for producing a glass substrate for information recording media according to claim 1, which includes, after the finish polishing step, a cleaning step that is carried out by using an alkaline cleaner having a pH of at least 10.

13. A glass substrate for information recording media, produced by the process as defined in claim 1.

14. A magnetic recording medium having a magnetic recording layer formed on the main surface of the glass substrate for information recording media as defined in claim 13.
